(19) United States
(12) Patent Application Publication
(10) Pub. No.: US 2014/0202151 A1
(43) Pub. Date: Jul. 24, 2014

(54) Hybrid Air-Cooled Condenser For Power Plants and Other Applications

(71) Applicant: Alliance for Sustainable Energy, LLC, Golden, CO (US)

(72) Inventors: Desikan BHARATHAN, Lakewood, CO (US); Thomas WILLIAMS, Arvada, CO (US)

(73) Assignee: Alliance for Sustainable Energy, LLC, Golden, CO (US)

(21) Appl. No.: 14/159,328

(22) Filed: Jan. 20, 2014

Related U.S. Application Data
(60) Provisional application No. 61/754,818, filed on Jan. 21, 2013.

(51) Int. Cl. F28D 15/00

(52) U.S. Cl. CPC F28D 15/00
USPC 60/641.2; 165/104.21; 165/96

(57) ABSTRACT

A hybrid air-cooled condenser system. The system may be provided by converting one among the many air-cooled condensers or condenser bays of a conventional condenser system to an evaporative cooler or condenser. The evaporative condenser may be plumbed in the condenser system to be in series in the vapor path with, upstream or downstream of, the air-cooled condensers. In one embodiment, the working fluid flows from an output or discharge header of the air-cooled section or assembly of the hybrid condensing system to an inlet of the evaporatively cooled section, e.g., to one or more evaporative coolers or condensers. In one modeled geothermal power plant, the condensing load on the air-cooled section was reduced by 50 percent when compared to a fully air-cooled condenser system. The condenser arrangement may be used to improve summer time performance of geothermal power plants.

### CROSS-REFERENCE TO RELATED APPLICATIONS

This application claims the benefit of U.S. Provisional Application No. 61/754,818 filed Jan. 21, 2013, which is incorporated herein by reference in its entirety.

### CONTRACTUAL ORIGIN

The United States Government has rights in this invention under Contract No. DE-AC36-08GO28308 between the United States Department of Energy and the Alliance for Sustainable Energy, LLC, the Manager and Operator of the National Renewable Energy Laboratory.

### BACKGROUND

Geothermal electricity is electricity generated from geothermal energy, and a variety of power plant technologies (or “geothermal power plants”) may be used to convert geothermal energy into electricity including dry steam power plants, flash steam power plants, and binary cycle power plants. Geothermal power plants are similar to other steam turbine thermal power plants as heat from a fuel source, such as the Earth's core in the case of geothermal power, is used to heat water or another working fluid to turn it into steam. The vaporized working fluid is used to turn a turbine of a generator to produce electricity. The working fluid (e.g., vapor output from the turbine) is then cooled, e.g., to return it to its liquid phase, and returned, in some cases, to the heat source (injected into the ground) or to a heat exchanger for heating to steam or a vapor to again turn the turbine.

The thermal efficiency of geothermal power plants is relatively low, e.g., in the range of 10 to 23 percent, because geothermal fluids are at a low temperature compared with steam from boilers. This low temperature limits the efficiency of heat engines in extracting useful energy during the generation of electricity. The efficiency of the system does not affect operational costs as it would for a coal or other fossil fuel plant, but it does factor into the viability of the plant.

Hence, it is desirable to maintain or increase the efficiency of geothermal power plants. For example, electricity is at its highest value during peak usage times, which is typically during the day such as when air conditioning loads are the highest and industrial plants are operating at full capacity. Therefore, it is desirable to maintain or increase a geothermal power plant's efficiency at these high value times such as the middle of the afternoon.

As discussed above, a number of power plant technologies may be used to provide geothermal power plant. Most of these power plant designs, though, will include a condenser system that is used to cool the vapor exhausted from the turbine(s). In areas where water is readily available, the condenser system may be made up of one or more evaporative coolers, e.g., cooling towers or the like, as such coolers are quite effective in cooling the working fluid. This allows the pressure of the vapor behind, or input to, the turbine to be maintained at lower levels. Such low working fluid pressures are desirable as a turbine will produce more work if the condenser pressure is reduced.

Unfortunately, there are many geographical areas where geothermal energy is readily available but water is scarce or expensive or both. In such dry and, typically, hot locations, an ongoing challenge for designers of geothermal power plants is how to provide effective cooling and condensing of the working fluid so as to retain or improve power plant efficiencies. In such areas, geothermal power plants or stations include a plurality of air-cooled condensers to provide cooling of the working fluid downstream from the turbine. Briefly, in air-cooled condensers, fans are used to draw air at ambient temperatures over coils or tubes carrying the working fluid vapor so as to cool and condense the working fluid.

For example, a bank of 8 to 10 or more air-cooled bays of the condensers may be arranged in parallel to receive the hot vapor from the turbine and to output a cooled and condensed working fluid that can be returned to the heat exchanger and then to the turbine inlet. A major concern, though, with the use of air-cooled condensers is that efficiency is directly linked to ambient temperatures (or temperature differentials between the working fluid and the ambient air). More specifically, the efficiency of air-cooled condensers decreases with rising ambient temperatures such that the air-cooled condensers are at lower efficiencies during the hottest portions of the day which, unfortunately, is when the electricity output by the power plant are at higher (or even highest) values.

In other words, a condensing system for a geothermal power plant may operate adequately or with high enough efficiency during cooler portions of the day (such as during the evening and at night) but may not be able to support lower working fluid or vapor pressures for the turbine exhaust during hotter portions of the day. As a result, geothermal power plant designers continue to search for a power plant design that mitigates the influence of high ambient temperatures on the power plant, e.g., the reduced condenser efficiencies associated with air-cooled condensers associated with increased temperatures of the air that is used to cool the working fluid. Similar phenomenon occurs in other condenser applications in cases such as in building air conditioners and other process condensers.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods that are meant to be exemplary and illustrative, not limiting in scope. In various embodiments, one or more of the above-described problems have been reduced or eliminated, while other embodiments are directed to other improvements.

To address the above and other concerns, the following description teaches various embodiments for a hybrid air-cooled condenser system for use in geothermal power plants. The condenser system is configured to mitigate the problems associated with use of air-cooled condensers in geographical regions that are dry (i.e., regions where water is not readily available to support full use of an evaporative cooler for the condensing system) and hot such that air-cooled condensers are less efficient.

Briefly, one exemplary hybrid air-cooled condenser system may be provided by converting one among the many air-cooled condensers (or condenser bays that include a bundle of tubes arranged for easy handling) of a conventional condenser system to an evaporative cooler or condenser. The evaporative condenser may be plumbed in the condenser system to be in series in the vapor path with (upstream or downstream of) the plurality or assembly of air-cooled condensers. In one embodiment, the working fluid (e.g., working fluid in vapor form) flows from an output or discharge header of the air-cooled section or assembly of the hybrid condensing system to an inlet of the evaporatively cooled section (e.g., to one or more evaporative coolers or condensers).

In one modeled geothermal power plant, the condensing load on the air-cooled section or assembly was reduced by as much as 50 percent (when compared to a fully air-cooled condenser system). As a result, a condenser pressure reduction was achieved that corresponds to the temperatures at which the working fluid condenses. In this way, the novel condenser arrangement taught herein may be used to improve summer time (and other) performance of geothermal power plants. For a 10-megawatt (MW) power plant, for example, the improvements in the efficiency provided by an embodiment of the hybrid condenser system can result in net power yield of about 1.5 MW, which correspond with a 15 percent increase.

The evaporatively cooled section can be selectively controlled with a manual or automated controller to be turned on and off so as to be used as needed, such as during hotter portions of a day and/or seasonally (e.g., may only be needed or desired during the summer months), to limit the amount of water consumed in evaporation. Control over the condenser system including the evaporative condenser(s) may be adapted to adjust the amount of vapor condensation performed or provided by the evaporative condenser, e.g., to cause the evaporative condenser to perform 0 to 50 percent (or more) of the vapor condensation. Such variable vapor condensation (e.g., 30 to 50 percent when operating) may be desirable to suit ambient temperatures with more condensation performed by the evaporative condenser as temperatures increase and, again, to limit amount of water consumed by the condenser system. Control signals may be used to affect water flow and/or to control the amount of air flow through the evaporative cooler, e.g., controlling fan operations to control percentage of vapor condensation provided. In this way, the hybrid condenser system may be operated to provide a better use of a limited or scarce and, therefore, expensive water supply to obtain the most decrease in vapor pressure of the working fluid exhausted from the turbine.

In addition to the exemplary aspects and embodiments described above, further aspects and embodiments will become apparent by reference to the drawings and by study of the following examples and descriptions.

### BRIEF DESCRIPTION OF THE DETAILED DRAWINGS

Exemplary embodiments are illustrated in referenced figures of the drawings. It is intended that the embodiments and figures disclosed herein are to be considered illustrative rather than limiting.

FIG. 1 is a partial schematic of a geothermal power plant including a hybrid air-cooled condenser system using a single evaporative condenser to provide enhanced vapor condensation efficiency;

FIG. 2 is graph providing a comparison of condensing capacities for an air-cooled condenser system and a hybrid air-cooled condenser system; and

FIG. 3 is a functional block diagram of a hybrid air-cooled condenser system useful for providing condensation of a working fluid in a power plant with improved efficiency during periods of higher ambient air temperatures.

### DESCRIPTION

The following description teaches a hybrid air-cooled condenser (or condenser system) that is well-suited for use in geothermal power plants and particularly in locations where temperatures are relatively high and water is scarce and/or expensive (e.g., in desert or similar geographic regions). The condenser system is “hybrid” in that it uniquely combines the benefits of an evaporative cooler or condenser with those of air-cooled condensers.

Briefly, the condenser system may combine a plurality of air-cooled condensers (or condenser bays) with one (or more) evaporative condenser. The evaporative condenser may be plumbed into the condenser system to be in series with the air-cooled condensers (upstream, downstream, or even within the air-cooled banks). For example, the working fluid vapor may first be passed through the banks of air-cooled condensers and then input to the evaporative condenser for final cooling/condensation prior to being returned to the turbine inlet via a heat exchanger, with the working fluid being heated by steam or hot water piped from the ground.

The condenser system may include a controller or control system that operates to selectively operate the evaporative condenser to only use it when the air-cooled condensers benefit from assistance such as during the daytime or when ambient temperature exceeds a preset minimum. For example, the controller may turn the evaporative condenser on and off as needed or may control water and/or air flow (or other components) to adjust the percentage of vapor condensation provided by the evaporative condenser and, as a result, by the air-cooled condensers.

As background to the hybrid cooling taught herein, the inventors recognized or determined that evaporative cooling of the entire air-cooled condenser (ACC) air mass flow was unwieldy and impractical. Some efforts were made to use cooling sprays on air-cooled condenser coils, but a number of serious problems were encountered or identified. In this regard, there are long term problems due to corrosion and scaling on the finned tubes of the air-cooled condenser that would require maintenance and/or reduce heat transfer and efficiencies of the air-cooled condensers.

Additionally, the sprayed water forms puddles under the ACCs, and water drifts onto many other components, e.g., rain-like spray is emitted from air-cooled condensers that may be 60 to 80 feet or more above the ground. The water spray is carried away such that drift-based water loss is unacceptably high, and, further, water spray requires large parasitic losses for pumping the water. As a result, direct spraying of water onto conventional air-cooled condensers does not appear to be practical and actually, in several important ways, teaches against forming a hybrid condenser that includes an air-cooled condenser as taught and claimed herein.

However and despite such teaching or findings, the inventors determined that a hybrid air-cooled condenser system can be provided by combining a bank of air-cooled condensers (or an air-cooled condenser assembly or section) with one or more evaporative condensers or coolers (or an evaporative condenser assembly or section). The air-cooled condenser assembly is in fluid communication with the evaporative condenser assembly such that the working fluid of the geothermal power plant passes through the two condenser assemblies in a serial manner. For example, the evaporative condenser can be plumbed into the condenser system to receive at its inlet the working fluid from the outlet or discharge header of the air-cooled condenser assembly or section. The evaporative condenser then may include an enclosure to contain and capture cooling water for reuse.

The proposed hybrid condenser system provides a number of advantages while only requiring a small amount of vapor side rerouting to be properly implemented in a typical geothermal power plant making use of a bank of air-cooled condensers. The hybrid condenser system confines water use to specific areas of the hybrid air-cooled condenser system, and the air-cooled condenser section or assembly can be isolated from spray/drift. There should be no water puddles, no spray carryover, and no drift losses in the geothermal power plant. The evaporative condenser may be implemented with a low water pressure distribution system with relatively low parasitic power. The technology that is useful or would be used to implement the hybrid condenser system is well within the design and fabricating capabilities of those skilled in geothermal plant and condenser arts. The condensing system with the evaporative cooler may be implemented so as to be much less costly than other proposed concepts under consideration by those in the power generation industry.

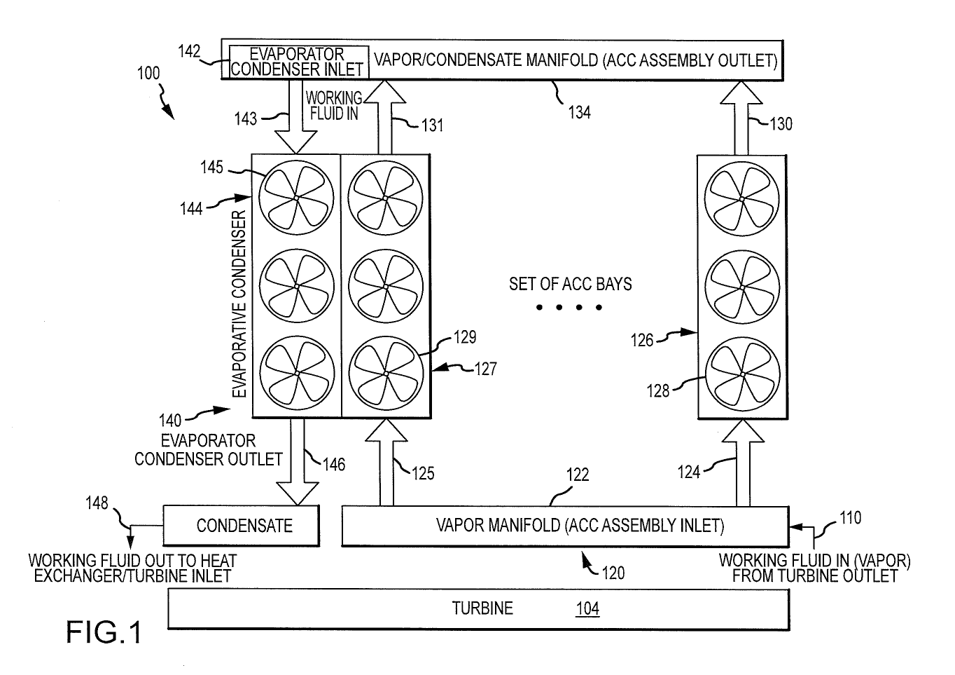

FIG. 1 illustrates a partial schematic for a geothermal power plant/station 100 making use of a hybrid air-cooled condenser as taught herein. Although not shown, the power plant 100 typically would include a generator as well as the illustrated turbine 104, and, as shown, the working fluid 110 is output from the turbine outlet as vapor. The working fluid 110 used in the system 100 may vary widely to practice the system 100, but, in some cases, the working fluid 110 may be pentane or a similar fluid used in geothermal power plants as the working fluid. Hence, the evaporative condenser 140 may be configured or adapted for use with the particular working fluid 110 (or for fluids with working parameters falling within a particular range).

The hybrid air-cooled condenser system of power plant 100 may be thought of as being provided by an assembly of an air-cooled condenser section or assembly 120 and an evaporative cooler/condenser assembly 140. Note, also, in geothermal power plant 100, the configuration shown in FIG. 1 may be replicated such as to provide another ACC section 120 with an evaporative condenser section 140, as many geothermal power stations may include two or more banks of condensers to cool working fluid from one, two, or more turbines 104. In the power plant 100, the ACC section 120 is upstream of the evaporative condenser section 140 and plumbed in series, e.g., the ACC assembly outlet 134 is in fluid communication with the evaporative condenser inlet 142. However, in other cases, the order may be reversed or the evaporative condenser assembly 140 may even be inserted between two or more of the ACC condensers 126, 127.

The power station 100 includes a turbine 104 that outputs hot working fluid 110, e.g., a volume of high-temperature vapor, which is fed into a vapor manifold or the ACC assembly inlet 122. The ACC assembly 120 includes a plurality of air-cooled condensers with end units 126, 127 shown in FIG. 1. For example, a bank of 3 to 19 or more ACC bays (with 7 to 9 being useful in some cases) may be provided in the ACC assembly 120. In some cases, retrofitting may involve removing one ACC bay from a set of ACC bays and inserting/providing an evaporative condenser assembly 140 in its place.

The working fluid 110 is fed as shown at 124, 125 from the vapor manifold 122 to the air-cooled bays or condensers 126, 127, which operate fans 128, 129 to draw cooling air at ambient temperatures across finned coils/tubes carrying the inlet vapor/fluid 124, 125 to produce a cooled (partially condensed) working fluid 130, 131. This vapor/condensate 130, 131 is fed into a vapor/condensate manifold or ACC assembly outlet 134. As shown, the air-cooled condensers/bays 126, 127 are arranged in parallel to concurrently provide the condensation of the working fluid 124, 125 from the turbine 104 with the manifold 122 dividing vapor/fluid flow as shown at 124, 125.

The hybrid air-cooled condenser system of power plant 100 is called “hybrid” because it uses a condensation method that combines air-cooling provided by the ACC section/assembly 120 with evaporative cooling provided by one or more evaporative coolers/condensers 144 that are provided in series with the ACC assembly 120. As shown, the ACC assembly outlet/manifold 134 discharges to (or is connected to) the evaporative condenser assembly 140 at the condenser inlet 142.

The evaporative condenser 144 is shown to include fans 145 for drawing air through a body and tubes/coils containing working fluid 143, and water is also sprayed/dripped within the body of the evaporative condenser 144 to provide evaporative cooling of the working fluid 143 and provide cooled/condensed working fluid at the evaporative condenser outlet 146. The working fluid/condensate 148 is then returned to the turbine inlet (e.g., via a heat exchanger in which it is again heated by steam or hot water or brine from the Earth).

The evaporative condenser assembly 140 may include an enclosure to trap and capture cooling water after it drains through the body of the condenser containing the working fluid 143 being cooled/condensed, and the evaporative condenser assembly 140 may also include a water/coolant supply, a pump(s), piping, and other accessories/components useful for directing the water used in evaporative cooling through the condenser 144 in a controlled manner. This can be achieved with flow control components that may be operated by a controller/control system (not shown in FIG. 1) to control the amount of water flow through the condenser 144 such as to select/adjust the percentage of vapor condensation provided by the evaporative condenser 144 and, hence, the ACC assembly/section 120. Further, the fans 145 may be selectively operated by a controller/control system to adjust/control air flow through the condenser 144 to adjust the amount of cooling/vapor condensation provided by the evaporative condenser section 140 and, therefore, the ACC section 120.

The inclusion of evaporative condenser 144 in the hybrid condenser system of power plant 100 is desirable for a number of reasons. First, all components such as fans and condensing tubes already exist or are available. Some redesign may be desirable and/or useful to suit the working fluid of a geothermal power plant and/or to provide series plumbing with an ACC section 140. Second, the designers and manufacturers of air-cooled condenser banks/bays for geothermal power stations typically have design and fabrication technologies as well as fabrication capacity and facilities in place to support inclusion of an evaporative condenser within a condenser system with air-cooled condensers. Third, surface condensers, cooling towers, and all the related components, which may be expensive, are avoided in the hybrid condensing system taught herein. An additional benefit arises when the condenser pressure goes below atmospheric pressure such that the air gets ingested in the system, requiring venting of the non-condensable gases in the system. During such periods when venting is required, the evaporative condenser can be operated at low temperatures to minimize or reduce working fluid emissions from the power plant.

The use of a series arrangement of the ACC section 120 and the evaporative condensers section 140 (either may be upstream in practice or the section 140 may be within the section 120) is desirable for a number of reasons. First, parallel vapor/working fluid flow between the two sections 120, 140 may be difficult to balance. Second, all vapor side valves are avoided in the hybrid condenser system. Third, for series flow, there is no need to split vapor flow. Fourth, when not in use, a bypass of the evaporative condenser 144 is not necessary, as there should be little pressure loss penalty to allowing flow through the evaporative condenser section 140 (without air or water flow).

The hybrid air-cooled condenser system of the geothermal power plant 100 of FIG. 1 may be modeled or implemented, for example, to provide the functionality of one half of a typical or commonly utilized condenser bay (e.g., the OEC-1 ACC). In such an implementation, the hybrid condenser system may be designed to provide a nominal 40 MW (thermal) capacity. The condenser system may include nine bays with eight bays being provided by the ACC section/assembly 120 and one bay being provided by the evaporative condenser section/assembly 140. Each bay/condenser may include a set of three fans although this number may readily be varied to implement the system 100. The nominal air mass flow may be 100 kg/s per fan in this example.

Using this model, a number of performance improvements compared to a wholly ACC condenser system can be determined or identified. First, calculations predict a 1.5 MW increase in net power. Second, air-side log mean temperature difference (LMTD) increases, which makes the ACC section 120 more effective than it would be without inclusion of the evaporative condenser section 140. Third, water flow may be about 150 gallons per minute (gpm), and there are no drift losses due to the use of an enclosure about/below the evaporative condenser 144. Fourth, the evaporative condenser assembly 140 may also be configured to confine the wet area under the evaporative condenser 144, e.g., the wet area is separated from the ACC section 120 and its ACC bays/units. Fifth, the evaporative condenser tubes may be galvanized or otherwise treated/selected such that fins are not required in the evaporative condenser 144. Sixth, less water is used than a similarly sized evaporative cooling system without air-cooled condensers, and the water is used more effectively. Seventh, release of non-condensable gases from the hybrid condenser system is more efficient. Eighth, the hybrid condenser system provides substantial reduction in hydrocarbon emission during venting at all times.

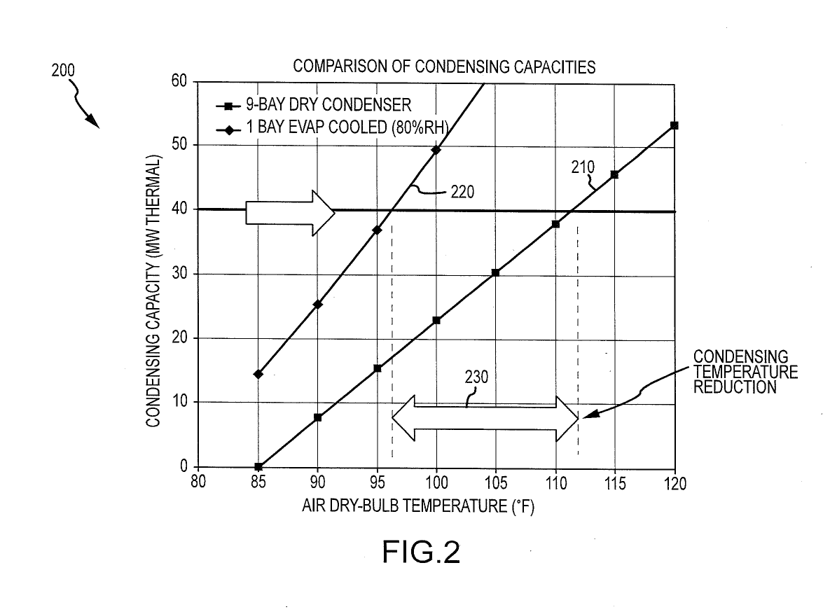

Performance improvement achievable with a hybrid air-cooled condenser system (such as the hybrid air-cooled condenser system of the geothermal power station 100 of FIG. 1) may be observed readily in the graph 200 of FIG. 2. The graph 200 provides a comparison of condensing capacities with line 210 showing capacities for a 9-bay dry (air-cooled) condenser system and with line 220 showing condensing capacities for a hybrid air-cooled condenser system (80% relative humidity (RH) at the exhaust) with 8 bays filled with air-cooled condensers and 1 bay filled with an evaporative condenser. Arrow 230 highlights the reduction that is achieved in the condensing temperature (for a 40 MW condensing capacity system). In producing graph 200, the following assumptions were used: air inlet temperature of 85° F.; RH of 25 percent; air out at RH 80 percent; and water evaporative loss of 146 gallons per minute (gpm).

With the condenser system of FIG. 1 and improvements shown by FIG. 2 in mind, it may now be useful to further describe the inventors' findings with regard to combining evaporative cooling with air cooling in geothermal power plants. In order that a hybrid system should be incorporated in a power plant, it should be designed so as to be functional, easy to implement, and practical to operate. To this end, key or useful considerations include the following concepts or inventor findings. In the hybrid system, the air-cooled condenser no longer is required to be designed for operation under the hottest days of the year. If the air-cooled condenser is designed for 90 percent (for example) of the peak load, it will adequately cool the plant for most of the year without needing to operate the evaporative cooling bay. In this manner, the capital and operating costs for the condenser is minimized. In the embodiments taught herein, the evaporative cooling is restricted to a single bay of the condenser, which reduces the volume of air to be humidified during hybrid operations to roughly only 10 percent of the total air mass, which achieves or provides more economical water use.

Additionally, use of water spray or fog preferably can be confined to a portion of the hybrid condenser system. This is desirable such that water sprays are not carried away from the needed areas. Otherwise, the use of water spray could end up making unnecessary pools of water on the ground making operation and maintenance difficult. Hence, in some useful embodiments of this description, use of water in contact with air is confined in devices such as within an evaporative cooler/condenser.

As discussed above, considering that a conventional ACC system normally would be formed to have many bays, each being served by a set of fans, it is convenient to use one of the bays as an evaporative cooler instead of all the bays being ACCs. The evaporative cooler/condenser chosen for inclusion in the hybrid condenser system may be sized to handle about 30 to 50 percent of the condenser system load or as needed depending upon the local climate of the plant location. The evaporative condenser typically is placed in series with the remaining bays, which are purely air cooled with air-cooled condensers, so as to produce a more efficient hybrid air-cooled condenser system (i.e., more efficient than a purely air-cooled system) that is well suited for use with nearly all geothermal power plant designs.

In some embodiments, an air-cooled condenser is removed from a bay and replaced with an evaporative cooler/condenser. In other cases, it may be desirable to retrofit an existing ACC system. In such a case, each bay of a conventional ACC system typically already has all the components needed to support an evaporative cooler. The fans and the tubes for the vapor flow exist (although the tubes may be replaced or modified so as to be galvanized and/or finless tubes) such that it may just be a matter of providing the water flow to deluge the tubes and recirculate the water. Water quality is not a concern because adequate blow down rates can be designed in or provided at the offset. During operations, the operator may simply turn on a switch to initiate water flow when needed. The operator can later turn it off, e.g., when the ambient air is cool enough to support condensation of vapor solely by the air-cooled condenser section/assembly, or the operator may regulate the flow of air and/or water such that maximum or at least increased benefit is obtained without using too much water. Completely automated control systems are also envisioned and may be incorporated in the hybrid power plant system.

With these practical considerations in mind, the following is one proposal generated by the inventors as a non-limiting example for successful implementation of hybrid cooling. One of a total of eight to ten bays of an ACC system/bank of condensers is “converted” to or replaced with a deluged, evaporatively-cooled condenser. This area of the hybrid air-cooled and evaporative condenser system is isolated such that water sprays do not get carried away. Air is directed to flow from bottom to the top. Water sprays deluge the entire set of tubes within this area. The entire condensed vapor and condensate are collected together after output from the air-cooled condensers (ACC section/assembly) and made to flow through the evaporative condenser section, where the last bit or remaining portion of condensation occurs (or first portion/fraction if provided in an upstream bay).

During times when this section is used with water deluge, it is expected that about 30 to 50 percent of the condensation will occur within the evaporative condenser section. These levels of condensation and corresponding heat load would be typically equivalent to an “effective” reduction in the intake air of about 4° C. to 8° C. The tubes and manifolds can be designed such that they can accommodate this level of the condenser duty. It is believed by the inventors that this type of arrangement for hybrid cooling is most practical for adoption within many geothermal power plants as well as other power plants or other process condensers.

As discussed above, the hybrid condenser systems taught herein provide a unique way to enhance the condensation performance achieved with air-cooled condensers. The hybrid condenser systems may be thought of as providing or using inlet assist, such as during hot weather (daytime in the summer or the like) operations. The following provides an example with relevant performance-related calculations to explain features or aspects of the hybrid condenser system concept as well as its benefits when compared with a conventional or standard air-cooled condenser system (or bank of a number of ACCs or ACC bays).

An air-cooled condenser system normally would include many fans with air-cooled condensers arranged in bays. For example, a common geothermal power station includes two air cooled condenser systems or banks of ACC bays. Each air-cooled condenser system includes 18 bays, with each bay having three fans for drawing cooling air over condensation finned tubes/coils in which the working fluid passes after driving a turbine. It should be understood by the reader that this is a non-limiting example that is specific to one particular configuration or a single plant design.

The nominal total heat rejection capacity for each air-cooled condenser system or bank of ACC bays is 80 MW (approximate thermal load). This 80 MW is carried by airflow to result in a 15° C. (typical) air temperature rise via sensible heat. The airflow required is provided by the following equation: \dot{m}_{α}=(80×100)/(1.005×15)=5306 kg/s. There are 54 total fans (18 bays multiplied by 3 fans per bay). Each fan induces a flow rate of about 100 kg/s, and this translates to a volume flow rate provided by the following equation: \tilde{V}=100/1.225=81.6 m³/s or 173,000 cfm. Based on design conditions, fans currently used (e.g., Moore Fans, LLC) are made with a design flow rate of \tilde{V}=227,435 acfm (at an air density ratio of 0.834) or 189,680 scfm. This indicates that the calculations performed are consistent. Again, these are only exemplary calculations/parameters for a particular design (as are specific examples provided the following several paragraphs), but they can readily be expanded or built upon by those skilled in the arts.

A hybrid condenser system may be created by converting one of the bays to an evaporative condenser as shown in FIG. 1 with evaporative condenser assembly 140, and this evaporative condenser is plumbed or connected to be in series flow (with regard to the working fluid) with the remaining air-cooled condensers. In this example, the eighteenth bay (of 18 total bays) is converted into an evaporative condenser. Then, a particular operating scenario may be considered for the hybrid condenser system.

Particularly, one may consider hot weather operation (e.g., in Reno, Nev. or the like) such as a hot summer day with 30° C. dry bulb (DB) air temperature. Weather data may indicate a dew point of near 0 to 3° C., and, in this case, the air side enthalpy at the inlet would be 41.51 kJ/kg. For such a bay, the air flow rate may be 300 kg/s (i.e., 3 fans multiplied by 100 kg/s per fan). Yet again, these are only exemplary calculations/parameters for a particular design, but they can readily be expanded upon by those skilled in the arts.

It may further be assumed that one half of the total heat load is rejected using the evaporative condenser, e.g., the converted eighteenth bay with water assist. Then, the required enthalpy for the outlet air can be estimated by the following equation: Δh (kJ/kg)=40,000 kJ-s/300 kg-s=133 kJ/kg. Hence, the outlet enthalpy should be at: hₒᵤₜ=hᵢₙ+Δh=42+133=175 kJ/kg. The condenser operating at dry condition is operating at air out temperature plus pinch, which is approximately: 30+15+5=50° C.

With water assist, the evaporative condenser should operate with air temperature rise of one half of normal (i.e., dry section of condenser system takes one half of the load) as shown by the following: air outlet=30+7.5=37.5° C. while condenser operation is at 37.5+5=42.5° C. This reduction in condensing temperature yields an increase in power of nominally 125 kW/° C. to result in the following: ΔP=125×7.5=937.5 kW. This is significant as it represents the increase for each hybrid condenser system (or bank of air-cooled condensers modified to include one evaporative cooler/condenser).

With the condensing temperature known, the evaporatively cooled (or wet cooled) section can be evaluated further to determine what it can attain in terms of an air outlet temperature. If it is assumed that it can be the same as the dry section, the air outlet temperature would be 37.5° C. The maximum air enthalpy the evaporative condenser can carry is given by: hₛₐₜ (at 37.5° C.)=167.7 kJ/kg. This is insufficient to carry the load, but one may further consider making 2 bays evaporatively cooled such that air flow for the evaporative cooler is 600 kg/s (note that dry air flow for the other part decreases by the same amount). Now, the required air outlet enthalpy is given by: 42+133/2=109 kJ/kg. This can be achieved at 27° C. DP at the exhaust carrying a RH of approximately 50 percent.

Next, water consumption with a dry air flow rate of 600 kg/s is given by the following equations/calculations: Wᵢₙ=4.46 g/kg; Wₒᵤₜ=26.96 g/kg; such that ΔW=22.5 g/kg; and then, water used=600*22.5/1000=13.5 kg/s (or 214 gpm). This water use is less than having to evaporatively cool all the air. Total air of the dry air-cooled condenser system is 5306 kg/s such that to cool it by 7.5° C. one needs a water (evaporative) of: Inlet (or hin) is 30 C DB and 0 C DP; Outlet (or hout) 22.5 C DB and 7.23 DP; ΔW=7.46−4.46=3.00 g/kg; water required is 5306*3/1000=15,918=15.92 kg/s (or 252 gpm); based on 40 MW heat rejection water required is 40,000/2450=16.33 kg/s (259 gal/s). All water flows are approximately the same. If some sensible heat is taken by air, then water loss would be lower (possibly, insignificant).

With these calculations performed for one exemplary implementation, it may be useful to further discuss the advantages and attractiveness of such a hybrid air-cooled condenser system. Most portions of an evaporative cooler/condenser are present in a bay of an air-cooled condenser system, which facilitates modification/retrofitting to produce the hybrid system. In other cases, though, a conventional evaporative cooler configured for use with the working fluid is used to replace or is used in place of one of the air-cooled condensers.

For example, an air-cooled bay may include one to three or more fans mounted on the top of a body/housing to pull air up through the housing (i.e., cooling air enters from a lower portion/inlet). A condensing coil with a number of tube rows (optionally finned for heat transfer) is provided in the housing below the fans. The working fluid (vapor in) may enter at the upper portion of the coil, and the working fluid (vapor/condensate out) may exit at the lower portion of the coil.

To convert this air-cooled condenser in the bank of air-cooled condensers to an evaporative condenser, one can add water sprays (nozzles) within the housing at a point below the fans to saturate/contact the coils, an enclosure/containment to block the water exiting the bottom portion of the housing from drifting away (onto an adjacent air-cooled condenser), a pool/basin below the condenser housing for collecting/capturing the water after it has passed through the condenser housing/coil, and a water circulating system with a water pump for pumping the water from the pool/basin up to the nozzles/spray header.

A controller may be provided for selectively operating the water pump or valves in the recirculating system to control/adjust the water flow rate to obtain a desired amount of vapor condensation (heat removal) in the evaporative condenser portion of the hybrid condenser system. Also, the controller may control operation of the fans to adjust the air flow through the condenser housing to control the amount of condensation (on/off and/or fan motor speeds for adjusting fan speed and, therefore, air flow rates through the evaporative condenser). The vapor lines from the air-cooled condensers could be re-plumbed so as to be in series with the inlet of the cooling coils of the evaporative condenser of the hybrid condenser system.

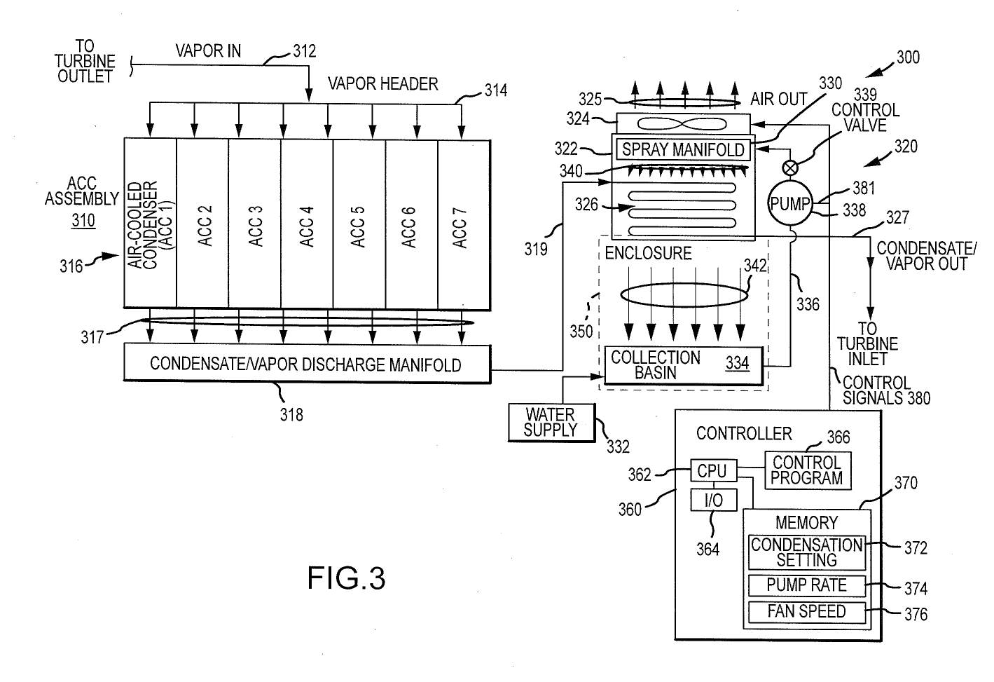

FIG. 3 illustrates a functional block diagram for a hybrid air-cooled condenser system 300. The system 300 includes an air-cooled condenser assembly 310 and an evaporative condenser assembly 320, and the assemblies 310, 320 may be used in a power plant to cool/condense a working fluid (e.g., downstream from a turbine not shown in FIG. 3). The working fluid or vapor is input as shown at 312 to a header 314 of an assembly or bank 316 of air-cooled condensers. For example, seven air-cooled condensers are shown in assembly or section 316, but other implementations of system 300 may include fewer or more air-cooled condensers in assembly or section 316. The air-cooled condensers of assembly 316 are arranged to operate on the input vapor/working fluid 312 in parallel and to output condensate/vapor as shown at 317 to a condensate/vapor discharge manifold 318.

The collected condensate/vapor (working fluid cooled by the air-cooled section/assembly 316) is transferred, such as by a series fluid connections, to the evaporative condenser assembly 320. Particularly, the evaporative condenser assembly 320 includes a cooling or condensate coil 326 within a body or housing 322 (e.g., galvanized tubing or the like extending from the top to the bottom of the housing 322 to provide coil 326) through which the working fluid is passed.

The working fluid 319 is injected into the coil/tubing 326 at an inlet and, after evaporative cooling, is ejected out as shown at 327 as condensate that is passed to the turbine inlet (e.g., via a heat exchanger where it is transformed into vapor with geothermal energy). The evaporative condenser assembly 320 also includes one or more fans 324 placed on or toward the top of housing 322 to draw cooling ambient air through the housing 322 and over coil 326 and then to discharge the air 325 out into the environment.

Further, the evaporative condenser assembly 320 is adapted for spraying cooling water 340 onto the coils 326 to cool the working fluid 319. To this end, the assembly 320 includes a nozzle assembly/spray manifold 330 placed above the coil 326 in the housing 322. The water 340 is sprayed from the manifold/nozzles 330 via recirculation line 336 in which a pump 338 is used to draw water up from a collection basin/pool 334 through a control/throttling valve 339 to the inlet of spray manifold 330. The evaporative condenser assembly 320 includes an enclosure 350 to contain the water discharge 342 from the coil 326 and to minimize drift onto the ACC assembly 310. However, water 340 typically will be lost with air 325 and/or through evaporation, and the assembly 320 may include a water supply 332 for making up lost volumes of water (and for initial fill and the like).

As discussed above, one useful aspect of hybrid condensing methods taught herein is that the evaporative condenser section may be selectively operated seasonally or selectively (off and on) daily to provide desired on demand additional cooling. Particularly, it may be useful to turn the assembly 320 off so as to rely solely upon the ACC assembly 310 for condensation of the vapor 312 (e.g., when the ambient air temperature is above a preset maximum value) and then to turn it back on to rely upon or use the evaporative condenser assembly 320 for a portion/fraction of the condensation (e.g., up to 30 to 50 percent or more of the vapor condensation provided by the system 300).

To this end, the system 300 is shown to include a controller 360 which may take the form of a computing device/computer or other electronic device with a processor 362 executing program or code stored in computer readable medium to perform particular functions (e.g., the software is executed to transform the processor 362 into a special purpose computer for performing the control functions described herein). For example, the processor 362 may run a control program 366 to selectively operate so as to transmit control signals 380 to the pump 338 and/or control valve 339 (as shown at 381) to control water flow to the spray manifold 330. Alternatively or additionally, the generated control signals 380 may include control data/signals for the motor controllers (not shown) of fans 324 to control air flow 325 through the coils 326.

The control program 366 may generate these signals based on condensation settings 372 stored in memory 370 defining the percentage of vapor condensation to be provided by the evaporative condenser assembly 320 (e.g., 30 to 50 percent in some applications so that the ACC assembly 310 provides 70 to 50 percent of the vapor condensation). The condensation settings 372 may be set or selected by an operator such as via input/output devices 364 (e.g., a touch screen, a keyboard, a mouse, a graphical user interface, or the like).

In other cases, sensor data (from sensors (not shown) in system 300) may be processed by the control program 366 to determine an appropriate condensation setting 372. Such processing may include determining ambient air temperature, relative humidity, pressure of vapor input at 312 and/or other operational parameters for system 300. The memory 370 may also be used to store pump rates 374 and/or fan speeds 376 (for use in issuing the control signals 380, 381). The values provided by rates and speeds 374, 376 may be set or determined by the control program 366 based on the condensation setting 372 (and, often, will vary based on the configuration of the evaporative condenser assembly 320 as well as the ACC assembly 310, e.g., based on the answers to the following questions: how many ACCs are provided?, what is their total capacity?, and so on).

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include modifications, permutations, additions, and sub-combinations to the exemplary aspects and embodiments discussed above as are within their true spirit and scope. For example, the use of the hybrid condenser system is shown to be used within a geothermal power plant or station, but the cooling process provided by this description and the supporting figures may also be readily implemented within other power plants (as the hybrid condenser system is not limited to use within geothermal applications) and other applications where it is desirable to cool and/or condense a working fluid (e.g., for use in HVAC and as, or with, other process condensers).

As discussed, the evaporative condenser assembly used in the hybrid air-cooled condenser systems may vary to practice the cooling concepts taught herein. A detailed evaporative condenser design would preferably be selected to or configured to address all or most of the following (with vapor side pressure loss considerations): condenser tubing sizes; length parameters/limitations; tube arrangements; water spray nozzles; coverage height demands; water hot well basin parameters; water accumulator configuration; and water pump specifications.

Several mechanisms and/or technological components are available to implement the systems and methods discussed in this specification such as to implement the controller 360 of FIG. 3. These may include, but are not limited to, digital computer systems, microprocessors, application-specific integrated circuits (ASIC), general purpose computers, programmable controllers and field programmable gate arrays (FPGAs), all of which may be generically referred to herein as “processors.” For example, in one embodiment, signal processing may be incorporated by an FPGA or an ASIC, or alternatively by an embedded or discrete processor. Therefore, other embodiments of the present disclosure are program instructions resident on computer readable media which when implemented by such means enable them to implement various embodiments. Computer readable media include any form of a non-transient physical computer memory device. Examples of such a physical computer memory device include, but are not limited to, punch cards, magnetic disks or tapes, optical data storage systems, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

1. A system for providing condensation of a working fluid, comprising:
an air-cooled condenser assembly comprising a plurality of air-cooled condensers; and
an evaporative condenser assembly comprising at least one evaporative condenser,
wherein, during operation of the system, a working fluid passes through the air-cooled condensers and the evaporative condenser to achieve vapor condensation and
wherein the air-cooled condenser assembly and the evaporative condenser assembly are plumbed to process the working fluid in series.

2. The system of claim 1, wherein the air-cooled condensers are arranged in parallel, wherein the working fluid output from the air-cooled condensers is collected in a discharge manifold, and wherein the discharge manifold is connected to an inlet to the evaporative condenser.

3. The system of claim 1, wherein the at least one evaporative condenser is configured to provide a portion of the achieved vapor condensation of the working fluid, whereby the evaporative condenser assembly provides additional cooling on hot days.

4. The system of claim 3, wherein the evaporative condenser assembly includes one or more fans selectively operated by a controller to set the portion of the achieved vapor condensation of the working fluid by adjusting air flow through the at least one evaporative condenser.

5. The system of claim 3, wherein the evaporative condenser assembly includes a water recirculation assembly including a pump and a control valve and wherein the pump or the control valve are selectively operated by a controller to set the portion of the achieved vapor condensation of the working fluid by adjusting a water flow rate through the at least one evaporative condenser.

6. The system of claim 1, wherein the evaporative condenser assembly includes a cooling coil for receiving the working fluid, a spray manifold above the cooling coil, a liquid enclosure, and a collection basin and wherein the collection basis is positioned below the cooling coil to receive water discharged from the spray manifold onto the cooling coil and the liquid enclosure contains the discharged water from drifting out of the evaporative condenser assembly onto the air-cooled condenser assembly.

7. The system of claim 1, wherein the working fluid is pentane.

8. The system of claim 1, wherein the air-cooled condenser assembly includes at least two of the air-cooled condensers arranged into a bank of condenser bays.

9. The system of claim 8, wherein at least one evaporative condenser is provided within one of the condenser bays adjacent to one of the air-cooled condensers.

10. A geothermal power plant, comprising:
a turbine; and
a hybrid air-cooled condenser system comprising an air-cooled section and an evaporative section,
wherein the air-cooled section and the evaporative section are plumbed together in series and
wherein, during operations, a working fluid is discharged as vapor to the hybrid air-cooled condenser system for vapor condensation.

11. The geothermal power plant of claim 10, wherein the evaporative section is selectively operable to provide 0 to 50 percent of the vapor condensation.

12. The geothermal power plant of claim 11, wherein the selective operating includes adjusting at least one of water flow and air flow through the evaporative section.

13. The geothermal power plant of claim 10, wherein the air-cooled section includes a plurality of air-cooled condensers arranged in parallel and wherein the evaporative section includes an evaporative condenser.

14. The geothermal power plant of claim 10, wherein the air-cooled condensers discharge the working fluid into a manifold in fluid communication with an inlet of the evaporative condenser.

15. The geothermal power plant of claim 13, wherein the evaporative section includes a liquid enclosure for containing cooling water discharged from the evaporative condenser, whereby drift of the cooling water onto the air-cooled condensers is blocked.

16. A method for controlling a hybrid condenser system, comprising:
operating a plurality of air-cooled condensers to perform a first fraction of vapor condensation of a working fluid; and
operating an evaporative condenser to perform a second fraction of the vapor condensation of the working fluid,
wherein the second fraction is between 0 and 50 percent of the vapor condensation.

17. The method of claim 16, wherein the air-cooled condensers and the evaporative condenser are plumbed in series with regard to the working fluid.

18. The method of claim 16, further comprising modifying operation of the evaporative condenser during the operating of the evaporative condenser to adjust the second fraction to be within the range of 30 to 50 percent of the vapor condensation.

19. The method of claim 18, wherein the modifying step is performed based on an environmental parameter.

20. The method of claim 19, wherein the environmental parameter is ambient air temperature.
